(19) United States
(12) Patent Application Publication
(10) Pub. No.: US 2020/0385903 A1
(43) Pub. Date: Dec. 10, 2020

(54) SPUN YARN WITH A STRUCTURE ENGINEERED TO REDUCE FIBER SHEDDING

(71) Applicant: Yitzac Goldstein, Seattle, WA (US)

(72) Inventor: Yitzac Goldstein, Seattle, WA (US)

(73) Assignee: Circular Systems S.P.C., Los Angeles, CA (US)

(21) Appl. No.: 16/431,603

(22) Filed: Jun. 4, 2019

(51) Int. Cl. D04H 1/42; B32B 5/02; B32B 5/26; D01D 5/26

(52) U.S. Cl. CPC D04H 1/42; B32B 5/02; D10B 2331/04; D01D 5/26; B32B 5/26

(57) ABSTRACT

The invention is a composite yarn construction whose structure provides more fiber-shedding resistance while preserving the look-and-feel characteristics of the underlying core structure.

### TECHNICAL FIELD

This is a staple fiber and filament fiber composite yarn whose structure reduces fiber shedding, during daily use and during water washing.

### BACKGROUND OF THE INVENTION

Each year, millions of tons of plastic waste enter the world's oceans and waterways. These plastics pollute the environment and damage the health of aquatic ecosystems. The environmental threat also impacts terrestrial organisms dependent on aquatic food sources, including humans, who are increasingly digesting plastic particles when we consume animal proteins, fresh produce, manufactured food and beverages, and drinking water.

Plastic consumption continues to rise each year. Not enough recycling infrastructure currently exists to curb the problem of waste entering aquatic environments, and because of the low price of virgin plastics, most recycled versions cannot compete anyway. With the extent of global attention focused on the problem currently by all sectors of society (media, trade, government, business, and consumers) the “tide” is set to change, including legislation-driven and market-driven actions to regulate and improve the manufacture, use, re-use, recycling, and disposal of plastic items (especially single use plastics).

New research has shown a particularly insidious form of aquatic plastic pollution has been occurring, from plastic textile fiber, most frequently that of polyethylene terephthalate (PET) polyester. The problem primarily results, not from the disposal of such non-biodegradable textiles, but from the water washing of such textiles, when fibers shed from the textile and into wastewater.

Fibers have been spun into yarns and made into textiles for thousands of years. Until the end of the 19^{th} century all available yarns were made of natural, biodegradable, materials, such as cotton, wool, silk, and linen. Starting in the early 20^{th} Century, yarns composed of man-made fibers were commercialized. In 1911, rayon became the first man-made textile material to reach the market. Although rayon is a man-made fiber, because of its composition of cellulose from plant materials, the resultant regenerated cellulosic polymer maintains the original material's biodegradability, and research has shown that the man-made version may even degrade faster than natural fibers. Cellulose acetate entered the market shortly thereafter, becoming the first commercially available thermoplastic, “plastic,” textile fiber. Although made from natural materials, plant cellulose and acetic acid, the resultant plastic polymer biodegrades more slowly than natural fibers.

The next generation of plastic fibers, nylon and polyester, both entered the market in 1940. These man-made fibers made from polymers synthesized from petrochemicals, became the first textiles on the market to persist in the environment over the long term with little to no biodegradation, the first truly “non-biodegradable fibers.”

Whereas by 1960, textiles of such non-biodegradable fibers comprised less than 10 percent of global fiber consumption, the market share increased to 50 percent by year 2000. As of 2017, total annual global textile fiber demand reached 106 million tons, almost double the year 2000 level, with the non-biodegradable fiber market share reaching 64 percent As the overall textile market continues to increase in size due to population growth and higher per capita textile consumption, and whereas arable land per capita, available for producing natural fibers, continues to decrease, Non-Biodegradable Fibers are expected to maintain this market dominance in the years to come.

Along with the enormous growth in the non-biodegradable fiber industry, plastics for other uses have seen a meteoric rise in production and consumption since the mid-Twentieth Century as well. From a 1.5 million tons per year production rate in 1950, the annual plastics production as of 2017 reached 348 million tons. Although a vast majority of plastics on the market are still petrochemical-derived, plastics partially or wholly from non-petroleum biological sources have entered the marketplace and are starting to gain market traction. Technology has also been developed to add certain catalysts to non-biodegradable fibers to promote biodegradation. Unfortunately, many of these “alternative plastics” only break down into smaller fragments in the oceans, “degrading”, instead of “biodegrading”. Truly biodegradable man-made fibers, whether sourced from petrochemical or biological raw materials, will be a welcome development in the textile industry, and will drastically improve the status quo. But, a common definition of “biodegradable” needs to be agreed. According to European Union funded research by InnProBio, the “Forum for Bio-Based Innovation in Public Procurement”, biodegradation is defined as a process by which microorganisms convert materials into carbon dioxide, methane, and biomass. This definition does not allow for mere “degradation” or “disintegration” wherein materials change in size into smaller and smaller particles through exposure to external forces such as heat, water, friction, and UV radiation but without the chemical conversion process via microorganisms.

InnProBio has delineated the time to achieve full biodegradation of natural fiber textiles in marine (saltwater) natural environments as one year or less. The US government's National Oceanic and Atmospheric Administration, “NOAA” has shown the rate of full degradation results of a cotton shirt in a marine environment of 2-5 months, compared to 1-5 years for a wool sock. By contrast, the same source also reveals that non-biodegradable plastics “may never entirely go away” and merely will turn into fine non-visible particles over hundreds of years. For this application, the definition of biodegradable is “a maximum rate of five years for essentially complete digestion by microorganisms in a marine environment of any material (whether biomass, biologic, or petrochemical origin) to methane and carbon dioxide.”

Most home washing machines are not equipped with filters which catch any fibers liberated from garments during the washing cycle before such fibers go down the drain. In wastewater treatment plants without fine filtration systems in place, some or all of these fibers will end up in aquatic environments. Even when some or all of these fibers are captured by fine filtration systems, they often end up in municipal sludge, which may then be used as a fertilizer or solid conditioner across wide swaths of land, where it often gets into runoff and still makes its way into aquatic environments. In the case of both terrestrial pollution and aquatic pollution of non-biodegradable textile fibers, research has shown that the fibers eventually degrade to a particle size which is digestible by both animals and humans, and is hazardous.

Another environmental concern regarding textile fiber shedding relates to the non-fibrous portion of such shed textile fibers. Such non-fibrous elements include, but are not limited to dyestuffs, softeners, lubricants, water-resistant or water-proofing agents, plasticizers, functional additives, and other chemical elements. Many of these non-fibrous elements have also been found to have deleterious effects on living organisms.

Although the building block polymers of biodegradable textile fibers are of less impact to the environment than non-biodegradable fibers, the release of such biodegradable textile fibers into the terrestrial and aquatic ecosystems has environmental toxicity concerns of its own when containing such non-fibrous chemical elements. Therefore, although non-biodegradable fibers are of highest environmental concern, efforts should be made also to control the release, by shedding, of biodegradable textile fibers into the environment.

Many solutions are being proposed which deal with this problem of environmental pollution from shed textile fibers, especially the shedding of non-biodegradable fibers. One proposed solution is for consumers to return to natural fibers. This solution is of limited value because of the overall size of the non-biodegradable fiber market and the rather limited present and future supply of natural fibers. Others are calling for mandating filters on clothes washers, and for installing better filters at wastewater treatment plants. Mesh bags for enclosing clothes during the washing cycle, with the densely woven fabric of such bags capable of blocking the escape of liberated textile fibers, are also now widely promoted. Filters are useful but other preventative measures must also be in place.

There is a critical need for technical solutions to provide for textile constructions which help to prevent the shedding of textile fibers during the pre-consumer and consumer washing phases. Research shows that the same textiles composed of yarns manufactured from non-biodegradable staple fiber yarns shed as much as seven times as much as those from yarns composed of non-biodegradable filament fiber yarns. An exception to this rule is where non-biodegradable filament yarn containing fabrics were brushed, breaking the continuous filament strands, shedding became exponentially worse than that of staple fiber yarns. Although one solution for reduced textile fiber shedding would be to replace all staple fibers yarns with filament fiber yarns, filament yarns and staple yarns have quite different aesthetic, tactile, and performance properties, so such a total replacement is not realistic. Therefore, an alternative solution for reducing the shedding of yarns containing staple fibers, especially those containing non-biodegradable textile fibers is urgently needed.

Over 81 million tons of yarns were produced in 2016. Spun yarns containing non-biodegradable fiber represent more than 25 percent of this overall yarn production, and more than 50 percent of the yarns used for knitted and woven fabrics for apparel and home textiles. Technologies which reduce fiber shedding in spun yarn textiles are critically needed, with non-biodegradable fiber shedding reduction being of highest concern for its environmental impacts, but also recognizing that biodegradable fiber, as well as non-biodegradable fiber, also present concerns from shed textile fibers due to the chemical constituents in their non-fibrous makeup.

### BRIEF DESCRIPTION OF THE INVENTION

This invention is a staple fiber and filament fiber composite yarn whose structure reduces fiber shedding caused from the frictional forces of daily use and water washing. In one embodiment, the composite yarn is a rotor-spun, wrap-spun yarn. In a second embodiment, the composite yarn is a jet-spun, wrap-spun yarn. Additional embodiments comprise filament wrap structures and core structures that all contribute to reduced fiber shedding while preserving the characteristics of the resulting composite yarn that are required for many different applications.

In addition to the distinct yarn structures, the invention has embodiments related to the constituent materials used for those structures. Here, again, the purpose is to reduce fiber shedding while preserving requisite application characteristics.

The overall invention structure reduces the number of a yarn's loose fiber ends. That, alone, significantly reduces shedding of all types of fibers—biodegradable and non-biodegradable. Embodiments with various combinations of filaments and fibers, both biodegradable and non-biodegradable, help ensure that along with reduced fiber shedding a disproportionate amount of shed fibers are biodegradable rather than non-biodegradable. That, in turn, reduces the environmental impact caused by fibers that are shed.

### BRIEF DESCRIPTIONS OF THE DRAWINGS

FIG. 1 illustrates a rotor-spun composite yarn apparatus.

FIG. 2 illustrates a lateral, cut-away, back-lit view of a, rotor-spun yarn with a core-spun filament yarn.

FIG. 3 illustrates a rotor-spun wrap-spun composite yarn comprising a filament wrap element.

FIG. 4 illustrates a second filament yarn delivery assembly is added to the machine of FIG. 1.

FIG. 5 illustrates another lateral, cut-away, back-lit view of a yarn showing a rotor-spun wrap-spun composite yarn comprising a filament wrap element and a WCSY filament core element.

FIG. 6 illustrates a jet-spun composite yarn apparatus.

FIG. 7 illustrates a jet-spun yarn is shown without the addition of any filament yarn element, and showing only staple fibers.

FIG. 8 a conventional jet-spun composite yarn structure of a staple fiber sheath and filament yarn core element.

FIG. 9 is a lateral, cut-away view showing a jet-spun wrap-spun composite yarn comprising a filament wrap element.

FIG. 10 illustrates adding a second filament yarn and filament yarn delivery assembly to the system compared to that shown in FIG. 6.

FIG. 11 is a lateral, cut-away, view showing a jet-spun wrap-spun composite comprising a filament wrap element and a WSCY filament core element.

FIG. 12 is a lateral, cut-away, view showing an embodiment of a filament wrap structure called an “air textured yarn” or “ATY structure.”

FIG. 13 shows another embodiment of a filament wrap structure called an “air-covered yarn” or “ACY structure.”

FIG. 14 shows another embodiment of a filament wrap structure called a “single-cover structure.”

FIG. 15 shows another embodiment of a filament-wrap structure called a “double cover structure.”

FIG. 16 shows rotor-spun wrap-spun or jet-spun wrap-spun composite yarn with a WSCY filament core yarn embodiment comprising a WSCY filament core yarn with a twist (added before spinning) in the opposite direction of the spinning twist.

FIG. 17A shows a cross section of a rotor-spun wrap-spun or jet-spun wrap-spun composite yarn embodiment with a TTR filament yarn core shown while such filament core yarn is still under tension, directly after spinning.

FIG. 17B shows the cross section of the yarn of FIG. 17A demonstrating the outward force of the core filament's crimps assuming their original shape after tension has initially been released, and before yarn take-up on the finished package.

FIG. 17 C shows the cross section of the yarn of FIG. 17A after tension has been released, in which such outward force demonstrated in FIG. 17B reduces the space between the staple fibers.

### DETAILED DESCRIPTION OF THE INVENTION

The invention herein disclosed and claimed is a composite yarn whose novel structure is primarily aimed at reducing fiber shedding. In addition, the structure lends itself to a variety of embodiments that support fiber-shedding reduction while preserving the required look and feel of the fabric constructed using this yarn.

Seventy-five percent of yarns globally produced for apparel and home textiles are spun yarns made from discontinuous lengths of fiber, called “staple fibers.” The other 25 percent of yarn production volume for apparel and home textiles is made from filament yarns. Filament yarns are made from one or more continuous lengths of filament fiber, generally man-made, with the small exception of silk filament.

Spun yarns composed of such discontinuous lengths of staple fibers are more prone to shedding compared to textiles composed of filament yarns. The exception to this rule is in the case of fleeced fabrics, otherwise known as “cut pile” textile fabrications, where the filament yarns are made into loops on the fabric surface and then such loops cut to make soft, loose ends.

Because spun yarns have a distinct look and feel compared to filament yarns, and spun yarns dominate the global market, directly replacing spun yarns with un-fleeced filament yarns is not advisable solely for the sake of reducing fiber shedding.

Staple fibers are held in place with a yarn matrix by inter-fiber coupling wherein multiple fibers' surfaces press against one another creating an adhesive force. Staple fibers, being discontinuous, have two ends per fiber, and all spun yarns have projecting loose fiber ends on the surface of the yarn, hereinafter referred to as “loose fiber ends,”, wherein one end of a fiber is anchored in the yarn structure and the other end projects from the surface of the yarn. As a fabric and yarn's surface comes in contact with frictional forces, such staple fibers with projecting loose ends may break away from the yarn, or the whole fiber may migrate out of the yarn, causing fiber shedding. Filament yarns may also shed fibers, even when uncut, if the individual filaments break during the use of fabrics containing such yarns. In the case of textile articles which require frequent water washing, such as wearing textiles and fashion accessories, as well as home textiles, water washing has a two-fold problem of both exposing yarns of the textiles to a multitude of fiber shedding frictional forces, but also the wash water becomes a vehicle by which the shed fibers enter the aquatic environment. In the case of machine washing, the shed fibers are drained with the wash water, often not caught by any filtration in a washing machine or water treatment plant thus eventually ending up in the marine environment. Similarly, clothing washed by hand, if washed in a freshwater source, will shed fibers that are carried by river currents to a marine environment.

Shed fibers that end up in marine environments are essentially of two categories: biodegradable fibers whose fiber polymers decompose into basic elements that pose little problem in themselves, although their associated non-polymer dyes and additives cause pollution in their own right; and non-biodegradable fibers whose polymers may decompose, somewhat, into smaller pieces but retain essentially the same chemistry as the original fiber. These non-biodegradable polymers have the same additional problem as the biodegradable ones, in that they often contain polluting dyes and other additives. So, although reducing non-biodegradable fiber shedding is the matter of greatest concern, there is a compelling argument to prevent the shedding of biodegradable fibers as well.

More than half of spun yarns contain non-biodegradable staple fibers, the category of greatest environmental concern. Such non-biodegradable fibers cannot currently be easily replaced because of their role in the yarns' hand-feel, strength, look, moisture management, cost, and ease of care.

In researching how to reduce staple fiber shedding, and the environmental impact from any shed fibers, while preserving the preferred look-and-feel of fabrics, it is found that loose fiber ends of more than 3 mm have a high likelihood of either breakage from the anchored part of the yarn, leading to shedding; or migration of the whole fiber away from the yarn structure, also leading to shedding. Therefore, the higher the amount of loose fiber ends longer than 3 mm on the surface of yarns after spinning, the higher the amount of shedding there will be in the textiles associated with such yarns. Of the three major systems for manufacturing spun yarns, ring spinning, rotor spinning, and vortex spinning, ring spinning has the most long loose fiber ends. Ring-spun yarns have approximately four times the amount of long loose fiber ends compared to rotor-spun yarns, and six times the amount of jet-spun yarns.

The finer the diameter of staple fibers contained within a spun yarn, the more fibers will be present per cross-section of yarn, and as a result there will be more loose fiber ends. For example, conventional 1.5 denier staple fiber replaced with a 2.0 denier thicker staple fiber may reduce the amount of loose fiber ends by 25 percent.

The larger the diameter of staple fiber, or filament fiber, the less likely there will be fiber breakage of any loose fiber ends, because larger diameter fibers are stronger than thinner ones.

Larger diameter staple fiber or filament fiber is less likely to escape filtration at a wastewater treatment plant and enter the marine environment.

Shorter staple fiber contained within a spun yarn produces more loose fiber ends and therefore more shedding. For example, conventional 38 mm length man-made staple fiber replaced with a 51 mm man-made staple fiber may also result in a 25 percent reduction in loose fiber ends.

Longer staple fibers, and more twists per length of multiple fibers creates more fiber to fiber adhesion. Such additional fiber to fiber adhesion, essentially locking the fibers in place, makes it more difficult for fibers to migrate to the surface of a yarn, and more difficult for any loose fiber ends to migrate out of the yarn structure, because the connected end will be anchored more strongly compared to a shorter fiber. For example, a 51 mm staple fiber will have 34 percent more twist revolutions per fiber compared to a 38 mm fiber.

The frictional forces of use and washing will increase the incremental damage to surface yarns. In addition to the original loose ends from the yarn manufacturing process, additional loose fiber ends will form as such frictional forces destroy the original orientation of the fibers within a yarn matrix. Abrasion resistance describes the strength by which a yarn's fibers resist being separated from the yarn matrix. The higher a yarn's abrasion resistance, the less likely new loose fiber ends will appear during usage. Ring-spun yarns have the highest abrasion resistance of the three major spun yarn types, followed by rotor-spun, with jet-spun being the least abrasion resistant.

Filament yarns, especially non-biodegradable ones, have a higher abrasion resistance than most spun yarns.

Adding twist to a filament yarn will increase its abrasion resistance, and twisting (plying) more than one filament yarn together also increases abrasion resistance

It is preferable to have biodegradable fibers on the surface of the yarn, because when shed, their environmental impact is generally lower than that of non-biodegradable fibers

The invention herein disclosed focused on improvements to rotor-spun and jet-spun yarns because of their already low propensity to shedding. Jet-spun yarns are those made on a yarn spinning system by which the twist of the spun yarn is inserted primarily by the action of a pressurized stream of fluid, such as air. Rotor-spun yarns are those made on a yarn spinning system, known as one of the open-end types, in which the twist of the spun yarn is inserted by a rotating rotor.

By adding a filament yarn to the surface of these yarn structures during the yarn spinning process, a “filament wrap,” making “rotor-spun wrap-spun composite yarns” and “jet-spun wrap-spun composite yarns,” can reduce shedding in several different ways.

The filament wrap helps to increase the abrasion resistance of a rotor-spun or jet-spun yarn's surface. As already stated, rotor-spun and jet-spun yarns have lower-shedding yarn structures, after production, compared to ring-spun yarns, but rotor-spun and jet-spun yarns are subject to more shedding, after extended use and washing, because of their lower abrasion resistance. Filament yarns are generally more abrasion resistant to their spun-yarn counterparts. So, a rotor-spun wrap-spun or jet-spun wrap-spun, containing surface filament content, may help reduce shedding by increasing the abrasion resistance of such yarns' surfaces.

A filament wrap displaces a portion of the staple fibers on the surface of the yarn. Less staple at the surface automatically results in fewer loose fiber ends from staple fibers on the surface of the yarn. As a result, with fewer loose fiber ends on the yarn surface, there is less propensity to shed. Filament yarns contain continuous filament fibers, and such filament fibers yarns do not shed, unless the filament yarns break from abrasion. And, even when broken, they will still shed less than does a staple-fiber surface.

In addition it was found that the compressive forces of a filament wrap against the staple fibers contained within the composite yarn, exerts additional pressure of the staple fibers against each other, therefore virtually locking them in place, reducing any chance for such staple fibers to migrate to the surface to produce additional fiber ends.

In order to prevent such a filament wrap from having a more harsh hand-feel compared to a conventional staple-surfaced jet-spun and rotor-spun yarn, a filament yarn with a spun-yarn-like hand-feel was added as the filament wrap yarn element. It is known to those in the art that passing single or multiple multi-filament yarns through a continuous jet of turbulent air or steam via a method called air texturing, or “ATY,” creates tangled loops on the surface of such yarns, which in turn simulates the hand-feel of a spun yarn. In using such an ATY filament yarn as the filament wrap on a rotor-spun wrap-spun composite yarn or a jet-spun wrap-spun composite yarn, the ATY structure filament wrap yarn not only reduces staple fiber shedding, but gives the composite yarn a more beneficial hand-feel of the ATY effect. In fact, it is known that the large quantity of loose fiber ends 2 mm to 3 mm in ring-spun yarns make the surface of such yarns much softer than the surface of rotor-spun and jet-spun yarns. Ring-spun yarns have nearly seven times more of these “beneficial loose fiber ends” compared to rotor-spun yarns; and eight times more than jet-spun yarns. In adding a ATY filament wrap structure, the inherent preferable lower shedding properties of conventional rotor-spun and jet-spun yarns is utilized, while also compensating for the lower amount of beneficial loose fiber ends. The ATY structure filament wrap gives the rotor-spun wrap-spun and jet-spun wrap-spun composite yarns the feel of such beneficial loose fiber ends, as found on a ring-spun yarn, but without the shed-prone longer-than-3 mm loose ends of the ring-spun structure

An ATY yarn may either be a single multi-filament yarn or may be multiple multi-filament yarns passing through the jet simultaneously. In most cases wherein multiple yarns pass through the jet simultaneously, there are two yarns, one which is under tension, the “core,” and one that has an overfeed compared the yarn under tension, “the effect.” The slack of the effect yarn allows it to form loops by its entanglement with the core yarn through the forces of the air or steam flow of the jet. Biodegradable filament yarns generally have a better hand-feel, but a lesser strength than equivalent non-biodegradable filament yarns. By using biodegradable filament yarns in the effect position and non-biodegradable filament yarns in the core position, the resulting filament wrap composite structure allows for a preferred hand-feel, and a good composite yarn strength, while at the same time ensuring that any fiber shedding from the ATY structure will be primarily of biodegradable filament fragments. This is true because the biodegradable portion of the ATY yarn is on the surface and subject to the most friction whereas the non-biodegradable core is away from the surface.

The structure of a filament wrap may also be adjusted using an air-covered yarn (ACY) structure. Like ATY, ACY can offer beneficial properties to the final rotor-spun wrap-spun and jet-spun wrap-spun yarns. In ACY, filament yarns are subjected an intermittent turbulent stream of air in an air-jet nozzle. In the manufacture of ACY yarns, two multi-filament yarns are normally used, one as a core, and one as an effect. The core yarn is held under tension while the effect yarn, as in the case of ATY, has some level of overfeed compared to the core. This allows the effect to essentially “cover” the core in between the instances where the jet tangles the two multifilament yarns together. As with the ATY structure, having a biodegradable effect and a non-biodegradable core, allows the biodegradable effect to be on the surface, giving that surface a preferable hand-feel, while also shielding the core from the forces of abrasion. Thus, most shed fragments from the wrap portion are biodegradable rather than non-biodegradable polymer content.

Using a single cover or double cover construction for the filament wrap, also known as “mechanical covered yarn” to those skilled in the art, may also bring additional shedding advantages to a rotor-spun wrap-spun or jet-spun wrap-spun construction. In both the single- and double-cover filament wrap constructions, such wrap contains a core filament yarn which is wound helically by a single filament yarn in the case of a single cover construction, or by two filament yarns, covering the core in opposite helical directions, in the case of the double cover construction. A single- or double-cover yarn construction allows for the selection of differential elements in the core area and in the cover area. For example, a monofilament yarn may be selected for the core, for high strength and low shedding, whereas a multifilament cover may be selected for good hand-feel. The helical orientation of the filament cover yarn(s) around the core of the single- or double-cover filament wrap also increases the abrasion resistance. Any frictional forces on the surface of a cover yarn divides the force over a much greater surface area of filament fiber, compared with a filament wrap yarn whose filament fibers travel solely in the direction of the spun yarn. For example, in a 1 cm length of a 150 denier yarn containing 72 filaments, used as a wrap, compared to a 1 cm length 75 denier 36 filament core yarn with a single cover of another 75 denier 36 filament yarn, covered at a rather average rate of 300 wrap per meter, the frictional force would act on 72 filaments in that 1 cm area in the first case and 108 filaments in the 1 cm area in the second case, thereby spreading the frictional force over a 50 percent larger surface area. As with the case of the ATY and ACY scenarios, having a filament wrap core of non-biodegradable filament yarn, and a surface of a non-biodegradable filament yarn, allows the benefit of the preferable hand-feel of the biodegradable portion, while also shielding the non-biodegradable portion from abrasion.

Twisting two or more filament yarns together also increases the abrasion resistance of the filament fibers contained within, so, adding a twisted filament composite yarn as the filament wrap, also is beneficial. Both methods rely on the same principal as in the single- and double-cover discussion, wherein any frictional force is divided over a larger surface area of filament fiber, and therefore lessens the impact on any single filament fiber. Furthermore, such twisting or plying makes the individual filament fibers more tightly bound to the single or plied yarn filament wrap matrix, and therefore lessens the amount of any loops of continuous filament fiber protruding from the filament wrap's surface. Decreasing the instance of any such loops will decrease the instance of snagging and breaking due to frictional forces. In the case of a twisted yarn structure of multiple filaments, in which some are biodegradable and some are non-biodegradable, the biodegradable adds softness to the structure while the non-biodegradable adds strength and abrasion resistance. And the biodegradable part at least partially reduces the friction on the non-biodegradable part, thereby reducing the instance of non-biodegradable filament fiber shedding.

Any of the above filament wrap variations may be additionally used with thermoplastic filament fiber yarns made from some or all thermally recycled polymers. Normally, thermally recycled polymers, such as from polyester textiles, PET bottles, or the like, make inferior quality yarns compared with those of virgin polymers. The individual filaments of such filament yarns with thermally recycled polymer content may be more easily broken, eventually causing shedding. It may also be economically unfeasible to produce yarns, with this content, having the fineness which produces good hand-feel. In addition, such thermally recycled polymer content yarn may also be more difficult to dye, or present more dyeing quality problems, compared to that of virgin polymer yarns. However, by combining such thermally recycled polymer content filament yarns with other yarns, whether of biodegradable fibers or virgin non-biodegradable fibers, simultaneous shedding reduction, hand-feel improvement, and dyeing quality improvement may be achieved. For example, a thermally recycled polymer content filament yarn may be the core element of a filament wrap such as a ATY, ACY, single cover or double cover. Or, it can be twisted with another kind of filament yarn.

Where a mono-filament filament wrap is used, shedding from the filament wrap portion will be substantially reduced compared to a comparable denier of multi-filament yarn. For example, using a 30 denier mono-filament filament yarn wrap, compared to a standard 30 denier 36 filament yarn as the filament wrap, the individual filaments of the 36 filament bundle will be easily broken and shed compared to the single 30 denier filament comprising the mono-filament yarn.

When non-biodegradable filaments are used in the filament wrap, it is preferable that such individual filaments are 1 denier or more in linear mass. Any individual filament of less than 1 denier is considered a “micro-denier” fiber. As discussed previously, the thinner the fiber, the more prone to breakage, shedding, and also the more likely such fibers will not be filtered at a wastewater treatment plant. One denier per filament yarns are still fine enough for the hand-feel standard of most commercial apparel and home textile applications, while at the same time being strong enough to avoid excessive breakage. For example a 75 denier 144 filament polyester yarn is a micro-fiber yarn in common usage, with each filament fiber equivalent to 0.52 denier. For the sake of shedding reduction in this invention, another commonly available yarn construction should be used such as 75 denier 72 filament, 1.04 denier per filament; or 75 denier 36 filament, 2.08 denier per filament.

By using a multifilament filament wrap yarn in which the yarn does not contain any intermingling points, the shedding reduction function of the filament wrap structure increased. Often filament yarns used in knitting or weaving undergo a treatment in which they pass through a jet nozzle with an intermittent flow of turbulent air for the purpose of intermingling portions of the filament fibers contained within the yarn. A yarn which does not undergo such a process is commonly known as a non-intermingled yarn, or “NIM” yarn. The individual filaments of an NIM multifilament yarn, when used as a filament wrap yarn, tend to spread out over the surface of the staple fibers contained within a rotor-spun wrap-spun or jet-spun wrap-spun composite yarn. Without the intermingling points which hold the individual fibers in bundles, and restrict the motion of individual filaments, the individual filaments of an NIM yarn are free to spread out across the yarn surface during spinning. The effect of having more surface area of the filaments of a NIM filament wrap pressing against the staple fibers contained within the composite yarn is that of a greater reduction in loose fiber ends, and a more comprehensive compressional force on the staple fiber contents, thereby locking more of the staple fibers in place due to increased inter-fiber friction between the staple fibers. Both the reduction in loose fiber ends and the additional compression both serve fiber shedding reduction functions.

As stated, there are environmental consequences of the shedding of both biodegradable and non-biodegradable fibers, but that if shedding occurred, the shedding of a biodegradable element would be preferred. Therefore, a novel construction is proposed wherein the filament wrap portion is entirely composed of biodegradable fibers, for example like non-thermoplastic man-made cellulosic filament, or silk. In one case where such a filament wrap would be very consequential would be wherein a rotor-spun wrap-spun or jet-spun wrap-spun yarn would have a biodegradable filament wrap, and staple content of cotton or other natural fiber. This structure becomes wholly biodegradable, while at the same time comprising a shedding-reduction function.

The addition of a filament core element during the spinning of a wrap-spun composite yarn, herein after referred to as a “WSCY” construction, could serve additional shedding reduction, especially non-biodegradable fiber-shedding reduction. The rotor-spun wrap spun with a WSCY filament core, and the jet-spun wrap-spun with a WSCY filament core, are both believed to be novel structures.

When rotor-spun wrap-spun and jet-spun wrap-spun composite yarns contain the addition of a WSCY filament core yarn, the staple fiber portions experience added compressional force from the filament wrap, by being squeezed between the filament wrap and the WSCY core. Such additional compression serves to increase the fiber-to-fiber friction between the staple fibers compared to a filament wrap alone. As a result, doing so further locks the staple fibers in place and further helps prevent loose fiber ends. It also reduces subsequent staple-fiber breakage or whole-fiber migration, thereby reducing fiber shedding.

A WSCY filament core yarn may be additionally composed of thermoplastic filament fiber yarns made from some or all thermally recycled polymers. Normally, thermally recycled polymers, such as from polyester textiles, PET bottles or such, make inferior quality yarns to those of virgin polymers. All the problems discussed above for using thermally recycled polymer content filament yarns as a filament wrap, may be avoided by using some or all of the desired thermally recycled polymer filament yarn content in the WSCY filament core location.

A basic WSCY filament core yarn structure may be improved if such yarn is composed of a non-heat-set multi-filament partially oriented yarn (POY) structure with a texturized crimp finish, a conventional product familiar to those skilled in the art, and in which such yarn is held under tension during spinning process. This removes all crimp texture until release of tension after the spinning process, but before winding of the finished yarn, when such WSCY filament core yarn expands in thickness. The structural result of this kind of yarn tension and tension release, “TTR,” is to put outward radial pressure on the staple fibers contained within the rotor-spun wrap-spun or jet-spun wrap-spun yarn, which creates added frictional force between the staple fibers, especially considering that this outward pressure is limited by the presence of the filament wrap. The end result is WSCY filament core with TTR structure in which the staple fibers are tightly locked in the yarn matrix and therefore such staple fibers are extremely limited in their ability to migrate and shed.

A WSCY filament yarn core may also be composed of a filament yarn with added twist before spinning, with such twist being in the opposite direction of that of the spinning process, called “a differential twist.” Again, this is another methodology to lock the components of the composite yarn structure together. Most core-spun yarns will have little adhesion between the staple and the filament core area. With such a WSCY filament yarn core with a differential twist, the staple content becomes more bonded with the filament core, thereby bringing more structural stability to the staple content.

Because more than 50 percent of all spun yarns contain non-biodegradable staple fibers, an important embodiment of this WSCY filament core portion of the invention includes the substitution of significant parts of the non-biodegradable fiber content to non-biodegradable filaments instead of the normally used non-biodegradable staple fiber. As mentioned before, non-biodegradable fiber constituents are often required in spun yarns for a variety of tactile, aesthetic, price and performance reasons. Most often the content of such non-biodegradable staple fiber content is between 30-100 percent of spun yarns. By placing up to 50 percent of non-biodegradable WSCY filament yarn in the core of rotor-spun wrap-spun and jet-spun wrap-spun composite yarns, the amount of non-biodegradable staple fiber can be reduced, acknowledging the tendency of staple fiber to shed more than filament fiber.

An example of a construction with reduced fiber shedding using this WSCY element would be with a man-made cellulosic filament wrap, a biodegradable staple content such as cotton, and a non-biodegradable core, such as polyester. In this case, both of the fiber surfaces generally exposed to frictional forces, the filament wrap and the staple content are biodegradable, and pose less environmental impact from shedding than from non-biodegradable fibers. The non-biodegradable portion is substantially or wholly covered by the filament wrap and staple elements. Also, since the non-biodegradable portion is only in filament form, it is unlikely to shed fibers, even if exposed to friction.

Another example of a reduced fiber shedding yarn using this WSCY element would be a non-biodegradable filament wrap, such as polyester, a biodegradable staple content, such as viscose staple fiber, and a non-biodegradable filament core, again such as polyester. In such a case, there is again no non-biodegradable staple fiber used in the construction, thereby significantly reducing the composite's yarn's non-biodegradable fiber shedding probability, yet still offering the advantage of the high abrasion resistance of a non-biodegradable filament wrap.

Another example of a reduced fiber shedding yarn using this WSCY element would be a non-biodegradable filament wrap, such as polyester; a biodegradable staple content, such as polyester staple fiber, and a non-biodegradable filament core, again such as polyester. Such a yarn construction is important to fulfill the 17 percent of the total spun yarn market which requires 100 percent non-biodegradable fibers, currently most of such demand being for 100 percent polyester staple fiber. The filament wrap and WSCY core construction ensures the minimum shedding of non-biodegradable staple fibers, while still maintaining a spun-yarn hand-feel.

In order to maintain a spun-yarn hand-feel in a spun composite construction containing a filament wrap component, it was found there is limit as to the amount of filament wrap portion which is possible without losing the requisite hand-fee. The top limit is essentially 25 percent. The addition of a WSCY filament core yarn component becomes especially important when limiting the filament wrap to 25 percent or less, but maintaining enough non-staple non-biodegradable fiber components. In this respect, the non-biodegradable components may be split between the filament wrap and core areas. A 45 percent non-biodegradable content may be achieved by placing, for example, 10 percent polyester content in the wrap element and 35 percent in the WSCY filament core yarn portion. In the case, for a example, of a 70 percent (non-biodegradable) polyester fiber/30 percent cotton or viscose (biodegradable) fiber yarn, a 15 percent polyester filament wrap may be used with a 30 percent WSCY polyester filament yarn core and a staple content of a blend of 25 percent polyester staple fiber and 30 percent cotton or viscose fiber. Here, although the yarn still contains non-biodegradable staple fibers, the amount of such fibers is severely restricted, and replaced by a combination of a filament wrap yarn component and a filament core yarn component, which is within the composite yarn overall 25 percent composition limit for preserving a spun-yarn hand-feel.

As described earlier, adjusting the staple fiber fineness and length may have significant impact on fiber shedding by decreasing the amount of projecting loose fiber ends and increasing the adhesion between the staple fibers. A 38 mm length, and 1.5 denier linear mass, is by far the most popular specification for spun-yarns made of man-made fiber. The next longer most commonly used length is 51 mm. A novel construction proposed herein combines the use of a rotor-spun wrap-spun or rotor-spun jet-spun composite yarn construction, combined with staples longer than 38 mm, and especially those with essentially 51 mm length. Conventional rotor-spun and jet-spun equipment may be used to spin fibers generally up to 51 mm length. Increased staple fiber denier is also possible on conventional rotor-spun and jet-spun equipment, and up to about 3 denier per filament, may still fulfill the hand-feel and performance requirements of many sewn product applications. This is especially the case with the addition of a filament wrap in which a hand-feel-improving element is added, as discussed above. A conventional rotor-spun or jet-spun yarn spun with only 51 mm length fibers versus 38 mm length fibers may reduce the number of loose fiber ends by 25 percent. A 38 mm length 3.0 denier staple fiber content may decrease loose fiber ends by 50 percent. A 51 mm length 3.0 denier content may decrease loose fiber ends by 63 percent. Adding a filament wrap element, adds to the already significant benefits of the additional length and coarser staples. For example, a yarn with a 35 percent non-biodegradable filament wrap, such as polyester, with a 65 percent 51 mm 3 denier biodegradable man-made cellulosic staple content, fulfills the requirements of a very popular fiber blend, with extremely low shedding, most importantly limiting the shedding of non-biodegradable elements because of the filament format of such non-biodegradable fiber, but also limiting the shedding potential of the staple fiber by increasing both the length and the thickness compared to conventional yarns. With the addition of an ATY structure filament wrap component, a beneficial hand-feel may be achieved which may partially compensate for the coarser staple fiber content.

Mechanically recycled staple fibers come from the cutting, shredding, and mechanical refining of pre- and post-consumer textile waste, such as yarn and fabric manufacturer's waste, clothing factory waste, or miscellaneous wastes from consumer use, such as apparel or home textiles. Currently mechanically recycled staple fibers are limited as to their use in consumer textiles because their short staple lengths, normally 15-20 mm, are significantly shorter than virgin cotton (28 mm average staple length) or man-made fibers (38 mm normal cut staple length). As mentioned previously, shorter fibers cause more loose fiber ends, and also have low fiber to fiber adhesion compared to longer fibers. The primary strategy for yarn manufacturers to increase the quality of yarns made of mechanically recycled staple fibers is to add 38 mm 1.5 denier non-biodegradable fibers such as polyester to the blend at between a 30-50 percent proportion by weight. One of the most important uses of the rotor-spun wrap-spun and jet-spun wrap-spun yarn constructions is to improve the quality of yarns containing mechanically recycled staple fibers, by reducing the shedding of such fibers without the use of staple non-biodegradable elements. A filament wrap may replace all of the staple non-biodegradable fibers normally used in a blend, while at the same time still reducing the overall shedding and improving the quality of the yarn. In some cases it may be preferable to still use some non-biodegradable fibers as a portion of the staple content. In that case, the filament wrap can contain the shedding of such non-biodegradable staple fibers. One embodiment of the invention includes the use of only biodegradable staple elements along with a minimum content of 20 percent mechanically recycled fiber in the composite yarn. For example, 40 percent mechanically recycled textile waste of 18 mm average length could be combined with 30 percent of 38 mm man-made cellulosic staple fiber, and 30 percent non-biodegradable filament wrap. The 38 mm man-made fiber adds strength and good processability to the blended staple component, while the non-biodegradable filament portion adds abrasion resistance, reduces projecting loose fiber ends, increases fiber to fiber cohesion, and has little chance of any non-biodegradable fiber shedding. In another embodiment, a 20 percent biodegradable filament wrap may be used, such as viscose filament, with a staple component of 50 percent essentially biodegradable mechanically recycled staple fibers, such as cotton with a small percentage of residual spandex fiber, with a 30 percent non-biodegradable WSCY filament yarn core, such as polyester. The character and hand-feel of the yarn will essentially be of that of a cotton spun yarn, but with the shedding control and softness of the biodegradable filament wrap, and the strength of the polyester filament core.

Staple fiber cut from lengths of extruded thermally recycled thermoplastic polymers (thermal recycling defined as from recycling processes which do not depolymerize and then re-polymerize raw material before extrusion to recycled fiber) has a lower strength and lower abrasion resistance than virgin fiber. Thermally recycled polymers normally are of cut lengths the same as virgin, that is, 38 mm or 51 mm, but their low strength and low abrasion resistance may cause more severe shedding, when spun into yarn, compared to using virgin staple fibers. For that reason, the abrasion resistant function of a flament wrap, in the spinning of rotor-spun wrap-spun and jet-spun wrap-spun yarns, may add additional fiber shedding reduction benefit when having themally recycled polymer staple-fiber content.

The invention is a composite yarn whose unique structure and content flexibility supports significant shedding reduction while preserving look-and-feel versatility. The structures herein disclosed have been spun on jet-spinning and rotor-spinning apparatus, with adjustments to the equipment, process, or raw materials to enable the novel structures. However it is the structure rather than the apparatus and settings that are herewith disclosed and claimed.

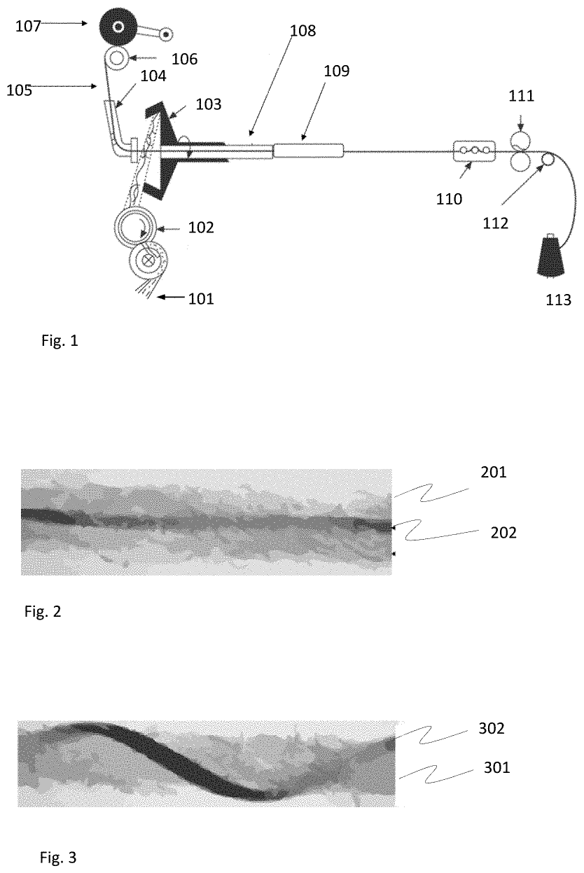

In FIG. 1 a rotor-spun composite yarn system is illustrated, such as used for staple/filament composite yarns, with the filament element conventionally located in the core of the “core spun” yarn.

FIG. 2 is an illustration of a back-lit rotor-spun yarn with a core-spun filament yarn. Such construction has a sheath of staple fibers (201) and a core of filament yarn (202. As can be seen, there is incomplete coverage rate of the filament core (202) by the staple sheath (201), as evidenced by the black color portions along the path of the filament core (202) which shows that the filament core appears on the surface of the yarn.

The apparatus of FIG. 1 is applied as follows: staple fiber slivers (101) are fed through an opening roller (102) into the rotor (103). A filament yarn (113) is fed through filament yarn delivery assembly comprising a yarn guide and tensioning device (112) then through positive feed rollers (111), through a tension meter (110), and then further into a filament yarn guide tube (109), where it is fed through the hollow spindle of the rotor (108) and joins the staple fiber inside the rotor (103). The composite yarn formed (105) in the rotor (103) travels through a doffing tube (104) wherein it is collected onto a finished package (107), by the action of a take-up roller (106).

By using the same rotor-spun equipment set-up as in FIG. 1, in which the settings of the filament yarn delivery assembly are adjusted with a higher filament yarn feeding rate and a lower filament yarn tension, compared to the core-spun yarn configuration, can result in a change in the location of the filament yarn of the composite. It may move from a position in the central core of the yarn, traveling parallel to the path of the composite yarn as in FIG. 1, to a location on the surface of the yarn, traveling in a helical direction in regards to the central axis as shown in FIG. 3, another backlit illustration.

In FIG. 3, the helically spun filament yarn element, the “filament wrap” (302) lies largely on the surface of the staple content (301). The settings of the filament yarn delivery assembly are controlled so that an excessive overfeed does not cause filament loops on the surface of the yarn. Novel structures can also be achieved with the structure illustrated in FIG. 3 by adjusting filament wrap content and structure using longer or coarser staples and/or mechanically recycled staple fibers.

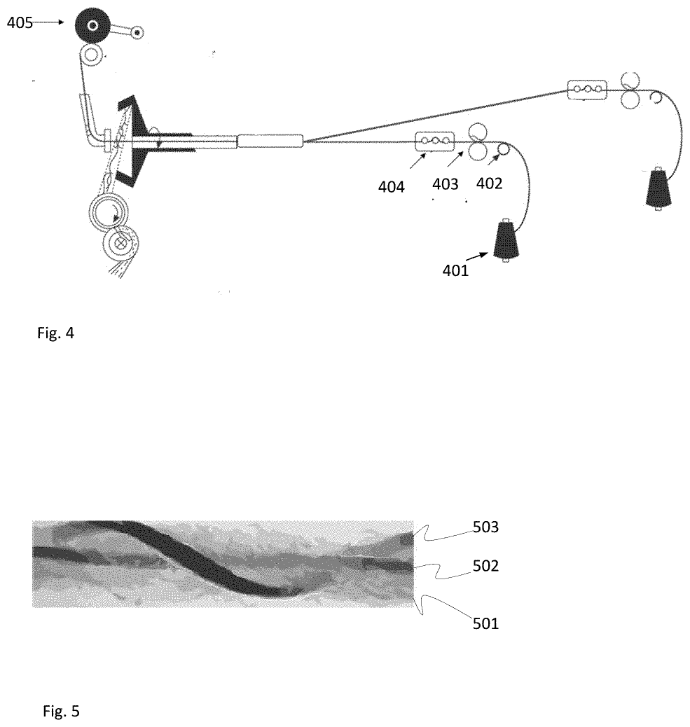

To achieve another novel structure disclosed in this application, a second filament yarn delivery assembly is added to the machine of FIG. 1, as shown in FIG. 4, such that a second filament yarn (401) now passes through a second yarn guide and tensioner (402), through a second set of positive feed rollers (403), and a second tension meter (404) so that second filament yarn joins the first filament yarn to pass through the filament yarn guide, hollow spindle, into the rotor, and becoming a composite yarn comprising a first and a second filament yarn plus staple fiber content.

As shown in FIG. 5, another backlit illustration, the staple fiber content structure is 501. The first filament yarn (503), with filament yarn delivery assembly setting for that of a filament wrap yarn as in FIG. 3, wraps helically on the surface of the yarn around the staple fiber content (501). The second filament yarn (502), having a filament yarn delivery assembly setting for that of a core yarn, as per FIG. 2, does not undergo any significant twisting during the spinning process and assumes a position largely in the central axis of the yarn and travels largely parallel to the path of the composite yarn. This filament core yarn of a rotor-spun wrap-spun composite yarn is a WSCY filament core yarn, as described earlier.

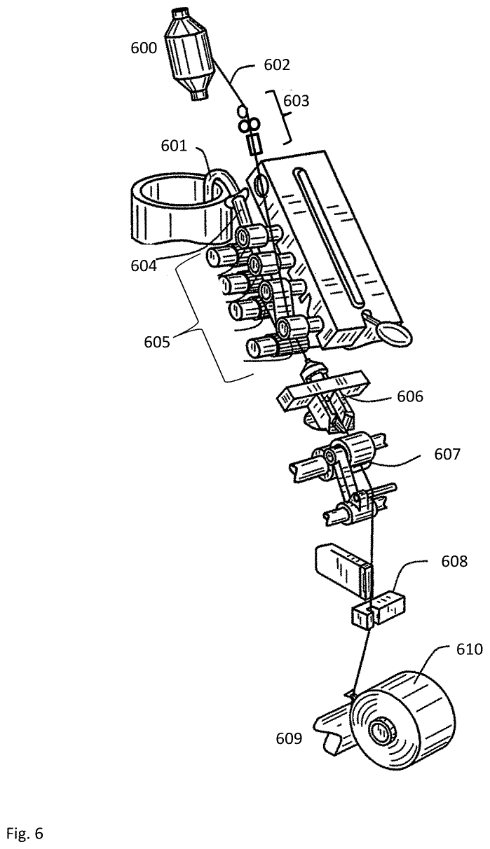

In FIG. 6, a typical jet-spinning machine is shown, typically used for the manufacture of a staple fiber/filament composite yarn in which the staple fiber comprises the sheath and the filament yarn comprises the core. The staple fiber content in the form of parallel slivers (601) is fed into a sliver feed tube (604) then through a drafting zone (605) comprising back, middle, apron and front rolls, and into a spinning nozzle (606). In some jet-spinning systems, more than one nozzle may be present. Also, as shown in FIG. 6, a filament yarn (600) is fed through a filament yarn delivery assembly (603), comprising a positive feed roller and a yarn tensioner, and then enters the last set of drafting zone rolls (605) where it is fed into the spinning nozzle (606) with the staple fiber together. The jet-spun composite composed of a staple fiber sheath and filament yarn core then proceed through delivery rolls (607), yarn clearer (608) and are wound on to a finished package (610) by the take up roller (609).

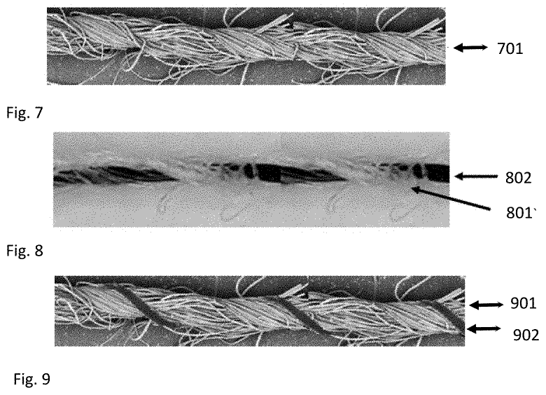

In FIG. 7, a jet-spun yarn is shown, without the addition of any filament yarn element, and only staple fibers (701) are present.

In FIG. 8 a conventional composite yarn structure of a staple fiber sheath (801), and filament yarn core (802) is shown. The filament yarn core (802) is delivered at a speed equal or lower to that of the staple fiber feed, and under such a tension that the filament yarn core assumes a position largely in the center of the cross-section of the yarn (the central axis), and as such, the filament yarn core does not undergo any significant twisting action inside the spinning nozzle, and the path of the filament yarn core is essentially parallel to the path of the composite yarn.

A novel structure embodiment for the reduction of fiber shedding may be achieved by changing the processing parameters of the filament yarn delivery assembly (603), as shown in FIG. 6, by lowering the tension setting of the yarn tensioner and increasing the speed setting of the positive feed rollers, thereby changing the position of the filament yarn from a position in the central axis of the yarn (FIG. 8, 802), to a “wrap” position, relative to the fiber (901) as shown in the filament wrap yarn (902) of the composite yarn of FIG. 9. Other novel structures based on that of FIG. 9 may be achieved by adjusting filament wrap content and structure using longer or coarser staples and/or mechanically recycled staple fibers.

This filament wrap yarn position is defined as largely on the surface of the composite yarn, and traveling in a helical path around the central axis of the composite yarn. The increased filament speed of the positive feed roller, and the lessening of the tension rate of the tensioner lower than that of a filament core yarn, puts slack in the filament yarn when it enters the spinning nozzle, thereby causing the filament yarn wrapping phenomenon of this jet-spun composite yarn invention.

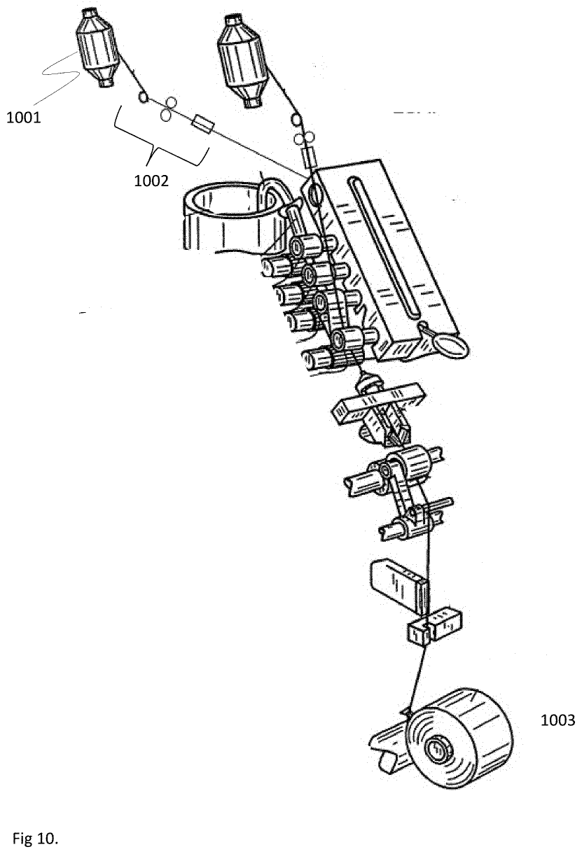

In FIG. 10, by adding a novel subsystem comprising a second filament yarn (1001) and filament yarn delivery assembly (1002) to the system compared to that shown in FIG. 6, we now have such second filament yarn (1001) passing through a second filament yarn delivery assembly (1002), the settings of which guide the yarn to the core position of the yarn. It is a WSCY filament core yarn. And, a first filament yarn (FIG. 6, 600) is now positioned by the settings of the first filament yarn delivery assembly (FIG. 6, 603) to assume a filament wrap position in the composite yarn. Both filament yarns now pass through the last set of drafting rolls in the drafting assembly (FIG. 6, 605), where the filaments join with the drafted staple fiber and continue to the spinning nozzle (FIG. 6, 606). This then results in a jet-spun wrap-spun composite yarn with a WSCY filament core yarn, which then proceeds through delivery rolls (FIG. 6, 607), yarn clearer (FIG. 6, 608) and are wound on to a finished package (FIG. 10, 1003) by the take up roller (FIG. 6, 609).

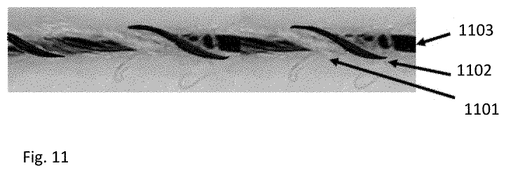

FIG. 11 shows the resulting novel jet-spun wrap spun composite yarn with a WSCY filament yarn core wherein the filament wrap (1102) wraps helically around the surface of the composite yarn of WSCY filament yarn core (1103) and staple fiber content (1101).

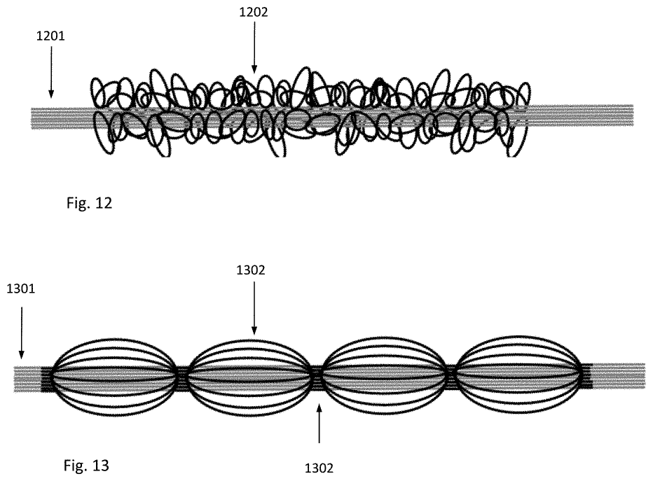

FIG. 12 shows another embodiment in filament wrap structure called an “air textured yarn” or “ATY structure”. ATY structures may either be of a single air textured multifilament filament yarn or one in which has a core multifilament filament yarn and an effect multifilament filament yarn. The diagram shows a core/effect style. The core (1201) is held under tension, while the effect yarn (1202) is fed into the jet at a faster rate, thereby creating the loops entangled with the core. A single-yarn ATY also has loops on the surface, but no core yarn.

Another embodiment of filament-wrap structure, shown in FIG. 13, is called an “air covered yarn” or “ACY structure.” ACY structures have a core multifilament filament yarn and an effect multifilament filament yarn. The core (1301) is held under higher tension than the effect yarn (1302) as the two yarns pass through an air jet with a stream of intermittent turbulent air, making intermittent points of entanglement (1302), with the result of the effect essentially covering the core in between the entanglement points.

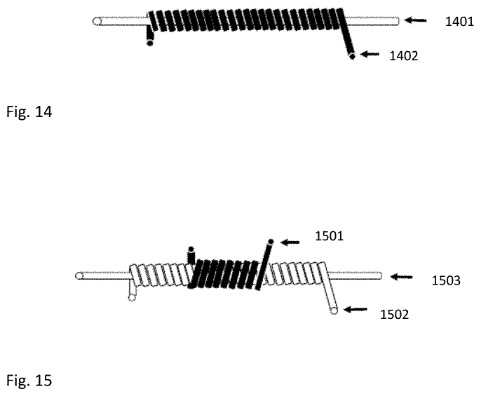

Another embodiment of filament-wrap structure, shown in FIG. 14, is called a “single cover structure.” Single-cover structures have a core filament yarn (1401), either monofilament or multifilament; and, a cover filament yarn, also either monofilament or multifilament (1402). The core filament yarn is fed through a rotating hollow spindle which holds a bobbin of filament yarn containing the cover yarn, and the cover yarn spools off the bobbin wrapping helically around the surface of the core yarn before the single cover filament wrap composite yarn is wound onto a finished package.

Another embodiment of filament wrap structure, shown in FIG. 15, is called a “double-cover structure.”. Double-cover structures have a core filament yarn (1503), either monofilament or multifilament; and an inner cover filament yarn (1502); and an outer cover filament yarn (1501), both covers either being monofilament or multifilament. The core filament yarn is fed through two rotating hollow spindles which hold bobbins of filament yarns containing the inner-cover yarn and the outer-cover yarns. These then spool off the bobbins wrapping helically around the surface of the core yarns in opposite directions before the double-cover filament wrap composite yarn is wound onto a finished package.

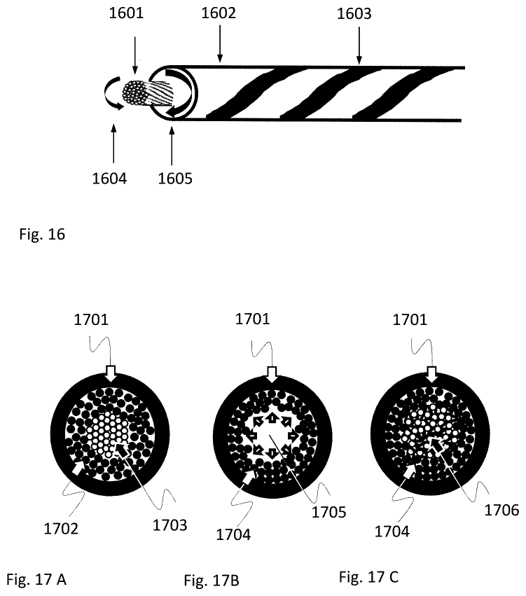

FIG. 16 shows a wrap-spun composite yarn (either rotor-spun or jet-spun) embodiment with a WSCY filament yarn core (1601). The staple fiber content is shown (1602) as well as the filament wrap (1603). The WSCY filament core is twisted before being spun into the core of this composite yarn, in such a manner that the twist direction of the WSCY filament yarn core 1604) is in the opposite direction of the yarn spinning (1605).

FIG. 17A shows a cross sections of a wrap-spun composite yarn (either rotor-spun or jet-spun) embodiment with a staple content element (1702) and a TTR filament yarn core element (1703), in a semi-finished state. During spinning a non-heat-set partially oriented yarn (POY) crimp texturized multifilament filament core yarn (1703), as known to those skilled in the art, is held under tension so that the crimps are flattened and the individual WSCY filament yarn core filaments are spaced relatively close to each other. The staple fibers of the composite yarn (1702) already have some degree of compressional force applied on them by virtue of being sandwiched between the filament wrap yarn (1701) and the WSCY filament core yarn (1703), but the compression is increased after the release of the tension on the WSCY filament core yarn. After the tension on the WSCY filament core is released, before being wound on the finished package, the WSCY filament expands in an outward direction (1705) as per FIG. 17B, and the staple content region (1704) can be seen more compressed against the filament wrap (1701). The final result is shown in FIG. 17C wherein the crimps of the WSCY filament core yarn are shown pressing the staple yarns outward towards the filament wrap, and locking them more solidly into place, thereby increasing the yarns overall shedding-reduction effect.

In addition to the structural embodiments of the jet-spun wrap-spun and rotor-spun wrap-spun composite yarns, the content proportions can be changed, as described earlier, to enhance shedding-resistance, to alter look-and-feel, or both.

The drawings and descriptions are meant to be exemplary and should not be read as limiting the scope of the patent. Although rotor-spinning and jet-spinning apparatus are alluded to in describing the end-result structures, the structures and not the apparatus used to attain those structures is the substance of the claims. This is not meant to be read as a product-by-process assertion and is meant to be exemplary and to show that these structures are not conceptual but attainable.

What is claimed is:

1. A system for reduced fiber shedding comprising:
a rotor-spun wrap-spun composite yarn.

2. A system for reduced fiber shedding comprising:
a jet-spun wrap-spun composite yarn.

3. A claim as in claim 1 further comprising:
a filament wrap comprises an ATY-based structure.

4. A claim as in claim 2 further comprising:
said filament wrap comprises said ATY-based structure.

5. A claim as in claim 3 further comprising:
said ATY-based filament wrap structure wherein a core element comprises one or more multi-filament yarns with non-biodegradable content; and
an effect element comprises one or more said multi-filament yarns with biodegradable content.

6. A claim as in claim 4 further comprising:
said ATY-based filament wrap structure wherein said core element comprises one or more multi-filament yarns with non-biodegradable content; and
said effect element comprises one or more said multi-filament yarns with biodegradable content.

7. A claim as in claim 1 further comprising:
said filament wrap comprises an ACY-based structure.

8. A claim as in claim 2 further comprising:
said filament wrap comprises said ACY-based structure.

9. A claim as in claim 7 further comprising:
said ACY-based filament wrap structure wherein said core element comprises one or more multi-filament yarns with non-biodegradable content; and
said effect element comprises one or more said multi-filament yarns with biodegradable content.

10. A claim as in claim 8 further comprising:
said ACY-based filament wrap structure wherein said core element comprises one or more multi-filament yarns with non-biodegradable content; and
said effect element comprises one or more said multi-filament yarns with biodegradable content.

11. A claim as in claim 1 further comprising:
said filament wrap comprises a single-cover structure.

12. A claim as in claim 2 further comprising:
said filament wrap comprises a single-cover structure.

13. A claim as in claim 11 further comprising:
a single-cover structure wherein a wrap cover filament yarn comprises a biodegradable multi-filament yarn and a core comprises a non-biodegradable multi-filament yarn.

14. A claim as in claim 12 further comprising:
a single-cover structure wherein a wrap cover filament yarn comprises a biodegradable multi-filament yarn and a core comprises a non-biodegradable multi-filament yarn.

15. A claim as in claim 1 further comprising:
said filament wrap comprises a double-cover structure.

16. A claim as in claim 2 further comprising:
said filament wrap comprises a double-cover structure.

17. A claim as in claim 15 further comprising:
said double-cover structure wherein a filament wrap core yarn comprises non-biodegradable fibers; and a filament wrap outer-cover filament yarn comprises biodegradable fibers.

18. A claim as in claim 16 further comprising:
said double-cover structure wherein a filament wrap core yarn comprises non-biodegradable fibers; and a filament wrap outer-cover filament yarn comprises biodegradable fibers.

19. A claim as in claim 1 further comprising:
said filament wrap comprises two or more said multifilament yarns plied together prior to being spun.

20. A claim as in claim 2 further comprising:
said filament wrap comprises two or more said multifilament yarns plied together prior to being spun.

21. A claim as in claim 19 further comprising:
said filament wrap comprises only two said multifilament yarns wherein one of said multifilament yarns is biodegradable and the other said multifilament yarn is non-biodegradable.

22. A claim as in claim 20 further comprising:
said filament wrap comprises only two said multifilament yarns wherein one of said multifilament yarns is biodegradable and the other said multifilament yarn is non-biodegradable

23. A claim as in claim 1 further comprising:
said filament wrap is composed of at least two filament yarns;
at least one said filament yarn comprises thermally recycled polymer fibers.

24. A claim as in claim 2 further comprising:
said filament wrap is composed of at least two filament yarns;
at least one said filament yarn comprises said thermally recycled polymer fibers.

25. A claim as in claim 1 further comprising:
said filament wrap comprises a single said multifilament yarn that has an added twist prior to being spun.

26. A claim as in claim 2 further comprising:
said filament wrap comprises a single said multifilament yarn that has said added twist prior to being spun.

27. A claim as in claim 1 further comprising:
said filament wrap comprises one or more said monofilament yarns each having a linear mass of up to 30 denier.

28. A claim as in claim 2 further comprising:
said filament wrap comprises one or more said monofilament yarns each having a linear mass of up to 30 denier.

29. A claim as in claim 1 further comprising:
said filament wrap comprises at least some non-biodegradable filaments wherein each said non-biodegradable filament has a linear mass greater than 1 denier.

30. A claim as in claim 2 further comprising:
said filament wrap comprises at least some non-biodegradable filaments wherein each said non-biodegradable filament has a linear mass greater than 1 denier.

31. A claim as in claim 1 further comprising:
said multifilament wrap comprises two or more said multifilament yarns wherein there is no intermingling or twisting of filaments contained within.

32. A claim as in claim 2 further comprising:
said multifilament wrap comprises two or more said multifilament yarns wherein there is no intermingling or twisting of said filaments contained within.

33. A claim as in claim 1 further comprising:
said filament wrap comprises only biodegradable filaments.

34. A claim as in claim 2 further comprising:
said filament wrap comprises only biodegradable filaments.

35. A claim as in claim 1 further comprising:
an added WSCY filament core yarn.

36. A claim as in claim 2 further comprising:
said added WSCY filament core yarn.

37. A claim as in claim 35 further comprising:
said WSCY filament core yarn comprises said thermally recycled polymer fibers.

38. A claim as in claim 36 further comprising:
said WSCY filament core yarn comprises said thermally recycled polymer fibers.

39. A claim as in claim 35 further comprising:
said WSCY filament core yarn comprises a TTR structure.

40. A claim as in claim 36 further comprising:
said WSCY filament core yarn comprises a TTR structure.

41. A claim as in claim 35 further comprising:
said WSCY filament core yarn has an added twist before spinning in the opposite direction of a spinning twist.

42. A claim as in claim 36 further comprising:
said WSCY filament core yarn has said added twist before spinning in the opposite direction of said spinning twist.

43. A claim as in claim 35 further comprising:
a composite filament core comprises non-biodegradable content;
a staple portion comprises biodegradable staple fibers;
and said filament wrap comprises biodegradable content.

44. A claim as in claim 36 further comprising:
said composite filament core comprises non-biodegradable content;
said staple portion comprises biodegradable staple fibers;
and said filament wrap comprises biodegradable content.

45. A claim as in claim 35 further comprising:
said composite filament core comprises said non-biodegradable content;
said staple portion comprises said biodegradable staple fibers;
and said filament wrap comprises non-biodegradable content.

46. A claim as in claim 36 further comprising:
said composite filament core comprises said non-biodegradable content;
said staple portion comprises said biodegradable staple fibers;
and said filament wrap comprises non-biodegradable content.

47. A claim as in claim 35 further comprising:
said staple portion comprises non-biodegradable staple fibers;
said composite filament core comprises said non-biodegradable content; and
said filament wrap comprises non-biodegradable content.

48. A claim as in claim 36 further comprising:
said composite filament core comprises said non-biodegradable content;
said staple portion comprises said non-biodegradable staple fibers;
and said filament wrap comprises non-biodegradable content.

49. A claim as in claim 35 further comprising:
said filament wrap and composite filament core in total are no more than 50 percent of total composite yarn weight;
said filament wrap is no more than 25 percent of said total composite yarn weight; and
said composite filament core is no more than 50 percent of said total composite yarn weight.

50. A claim as in claim 36 further comprising:
said filament wrap and said composite filament core in total are no more than 50 percent of total composite yarn weight;
said filament wrap is no more than 25 percent of said total composite yarn weight; and
said composite filament core is no more than 50 percent of said total composite yarn weight.

51. A claim as in claim 1 further comprising:
said rotor-spun wrap-spun composite yarn comprises at least 50 percent by weight of staple-content fibers greater than 38 mm in length.

52. A claim as in claim 2 further comprising:
said jet-spun wrap-spun composite yarn comprises at least 50 percent by weight of said staple-content fibers greater than 38 mm in length.

53. A claim as in claim 1 further comprising:
said rotor-spun wrap-spun composite yarn comprises at least 50 percent by weight of said staple-content fibers equal to or greater than 51 mm in length.

54. A claim as in claim 2 further comprising:
said jet-spun wrap-spun composite yarn comprises at least 50 percent by weight of said staple-content fibers equal to or greater than 51 mm in length.

55. A claim as in claim 1 further comprising:
said rotor-spun wrap-spun composite yarn comprises 20 percent or more by weight of mechanically recycled staple fiber.

56. A claim as in claim 2 further comprising:
said jet-spun wrap-spun composite yarn comprises 20 percent or more by weight of said mechanically recycled staple fiber.

57. A claim as in claim 1 further comprising:
said rotor-spun wrap-spun composite yarn in which any non-mechanically recycled staple fiber comprises only biodegradable fibers

58. A claim as in claim 2 further comprising:
said jet-spun wrap-spun yarn in which any non-mechanically recycled staple fiber comprises only biodegradable fibers.

59. A claim as in claim 1 further comprising:
said rotor-spun wrap-spun composite yarn which comprises only non-biodegradable fibers.

60. A claim as in claim 2 further comprising:
said jet-spun wrap-spun composite yarn which comprises only non-biodegradable fibers.

61. A claim as in claim 1 further comprising:
said staple content comprises said thermally recycled polymer fibers.

62. A claim as in claim 2 further comprising:
said staple content comprises said thermally recycled polymer fibers.
